(19) United States
(12) Patent Application Publication
(10) Pub. No.: US 2002/0046584 A1
(43) Pub. Date: Apr. 25, 2002

(54) Padlock utilizing pop-out cylinder

(76) Inventors: Jerry M. Lumpkin, Roanoke, VA (US); Peter H. Field, Salem, VA (US)

Correspondence Address: ROTHWELL, FIGG, ERNST & MANBECK, P.C., 555 13TH STREET, N.W., SUITE 701, EAST TOWER, WASHINGTON, DC, 20004, US

(21) Appl. No.: 09/983,228

(22) Filed: Oct. 23, 2001

Related U.S. Application Data
(60) Provisional application No. 60/242,145, filed on Oct. 23, 2000.

(51) Int. Cl. E05B 67/22

(52) U.S. Cl. 70/38 A

(57) ABSTRACT

A padlock includes a standard pop-out lock cylinder having a retractable bolt. The bolt is insertable into a channel in the padlock housing body containing ball bearings that fit against notches in a shackle of the padlock. The bolt provides a detent against which the ball bearings are forced against the notches of the shackle, locking it into a closed position. Upon rotation of the lock cylinder, the bolt is retracted, allowing the ball bearings to cam inward, thereby allowing the shackle to be released from the padlock housing body.

This application claims priority under 35 U.S.C. § 119(e) from provisional application Ser. No. 60/242,145 filed Oct. 23, 2000.

### BACKGROUND OF THE INVENTION

1. Field of the Invention

This invention relates generally to locks for securing objects such as lockers, gates, bicycles, etc., and more particularly to padlocks having an elongated shackle that is locked into a padlock body.

2. Background and Prior Art

Padlocks have been known in the art for some time. See, e.g., U.S. Pat. Nos. 5,363,678, 5,377,511, and 5,896,761. Typically, padlocks have been designed to accept locking mechanisms specifically manufactured to fit within the padlock housing body.

For example, as shown in FIG. 1, a prior art padlock 100 includes a padlock housing body 101, a shackle 103 having a first square notch 105 and a second rounded notch 111, a lock 109 having a rotating cam 107 with an extended dog 107a, and a number of ball bearings 113 in a channel adjacent to the cam 107.

When in the locked position as shown in FIG. 1, the cam 107 is rotated so that the dog 107a is oriented to be aligned inside the square notch 105 of the shackle 103. In this position, the elongated end of the cam 107 biases ball bearings 113 into the rounded notch 111. The dog 107a and ball bearings 113 act cooperatively to lock the shackle 103 in place inside the padlock housing body 101.

As shown in FIG. 2, when the proper key is inserted into the lock 109, the lock 109 can be rotated using the inserted key. Rotation of the lock 109 causes the cam 107 to be rotated until it reaches the position shown. In this position, the dog 107a is rotated out of the square notch 105, and the cam 107 is rotated such that its longer dimension is perpendicular to the ball bearings 113, allowing the ball bearings to be cammed inward when the shackle 103 is pulled upward as shown. Accordingly, the shackle is allowed to rotate freely with respect to the padlock housing body, biased in the unlocked position with a spring 115.

A shortcoming in such prior art padlocks is their inability to accept standard pop-out lock cylinders, i.e., lock cylinders having a bolt that extends out from the cylinder upon locking and retracts into the cylinder upon unlocking by rotation of a proper key inserted into the cylinder. Because of this shortcoming, specially designed locks were required to be manufactured to fit into a padlock housing body, thereby raising its cost.

A need thus exists in the art for improvements to the design of padlocks.

### SUMMARY OF THE INVENTION

The present invention provides a padlock which overcomes the problems mentioned above. In one embodiment, the padlock of the present invention is designed to accept any standard pop-out lock cylinder for use in securing the shackle of the padlock within the housing body.

In particular, the present invention provides a padlock, containing a housing body including a movable ball bearing provided in a channel, an elongated shackle movably provided in the housing body, the elongated shackle having a rounded notch for receiving the movable ball bearing therein when the shackle is in a closed position within the housing body, a popout lock cylinder having a bolt extendable and retractable out of and into the lock cylinder, the bolt being extendable into the channel containing the movable ball bearing to force the ball bearing against the rounded notch, thereby locking the shackle in said closed position, the bolt further being retractable into the popout lock cylinder to release the ball bearing from the rounded notch, thereby allowing the shackle to be raised to an open position out of the housing body.

### BRIEF DESCRIPTION OF THE DRAWINGS

The present invention will become more fully understood from the detailed description given hereinbelow and the accompanying drawings which are given by way of illustration only, and are not limitative of the present invention, and wherein:

FIG. 1 is a part cross-sectional view of a prior art padlock in a locked position;

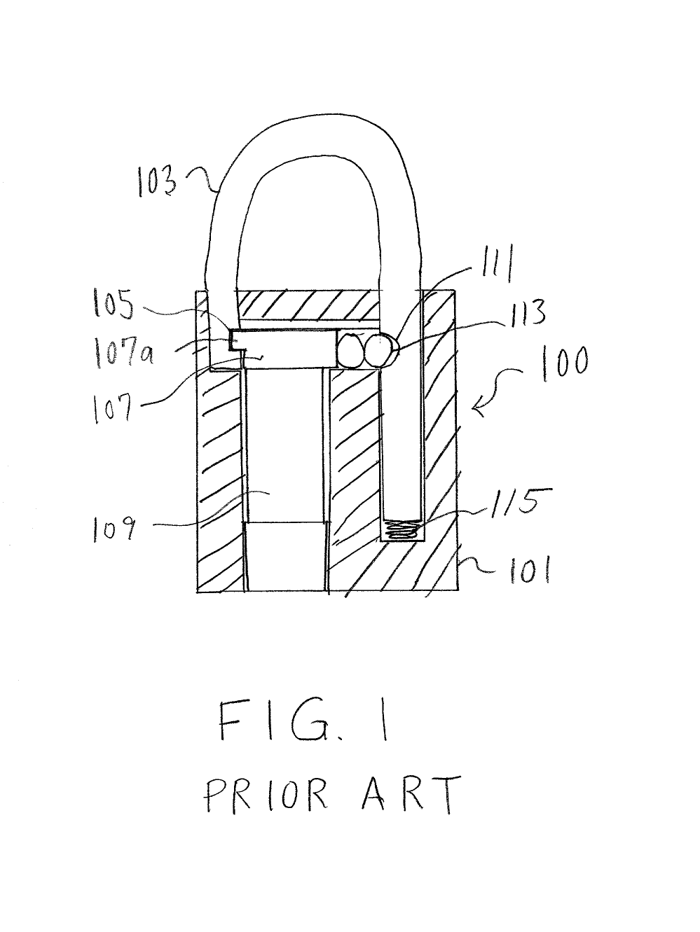

FIG. 2 is a part cross-sectional view of the prior art padlock of FIG. 1 in an unlocked position;;

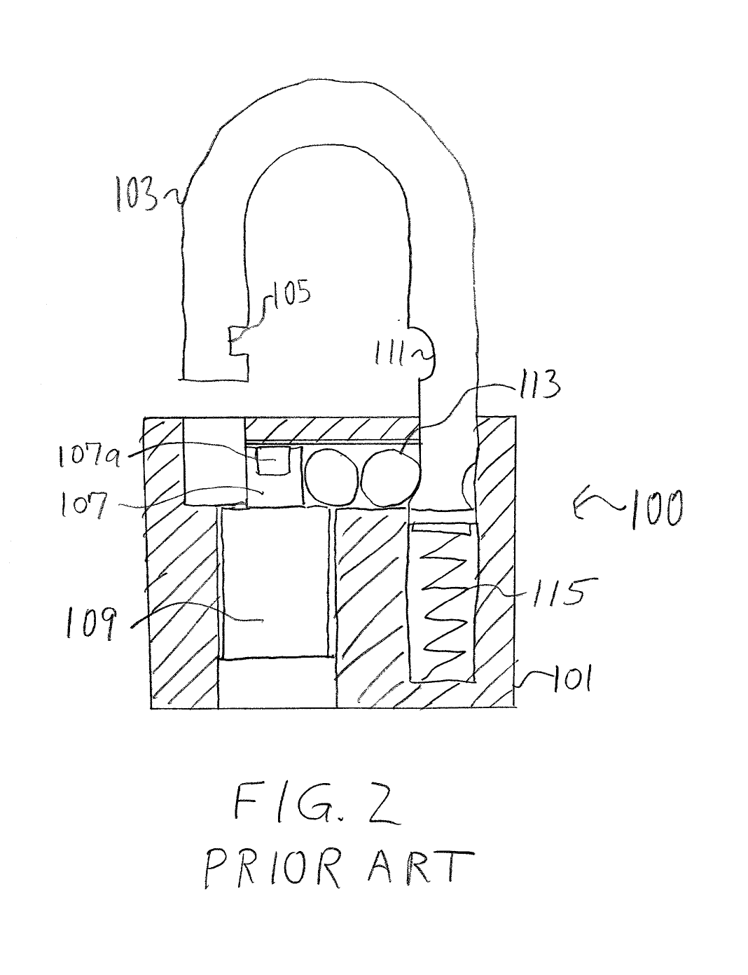

FIG. 3 is a part cross-sectional view of a padlock according to one preferred embodiment of the invention, in a locked position; and

FIG. 4 is part cross-sectional view of a padlock according to one preferred embodiment of the invention, in an unlocked position.

### DETAILED DESCRIPTION OF THE PREFERRED EMBODIMENTS

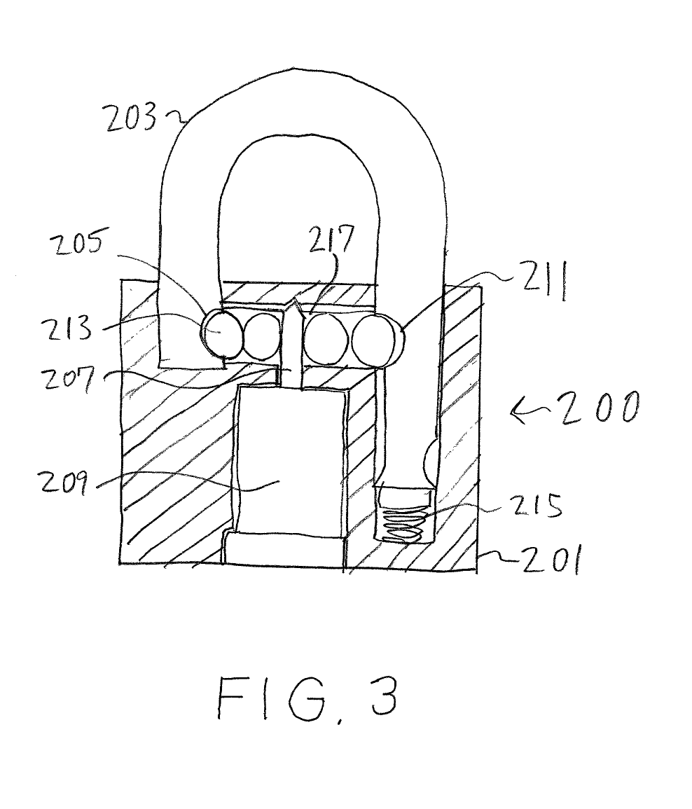

FIG. 3 shows a padlock 200 according to one preferred embodiment of the present invention. The padlock 200 includes a housing body 201, a shackle 203 having first and second rounded notches 205 and 211, a number of (spring-biased) ball bearing 213, a lock 209 having a retractable bolt 207, and a spring 215 for aiding in releasing the shackle from the housing body upon unlocking the padlock.

When the shackle 203 is pressed into the housing body 201 in the locked position as shown, the lock 209 is rotated into the locked position by a proper key (not shown) inserted into a keyway in the lock cylinder at the bottom of the padlock housing body. In this position, a bolt 207 extends outward from the lock cylinder 209 into the ball bearing channel 217. The extended bolt 207 causes the ball bearings to be forced in directions where ball bearings are biased into the rounded notches 205 and 211, acting as a detent. In such position, the shackle is secured inside the housing body, and cannot be released therefrom.

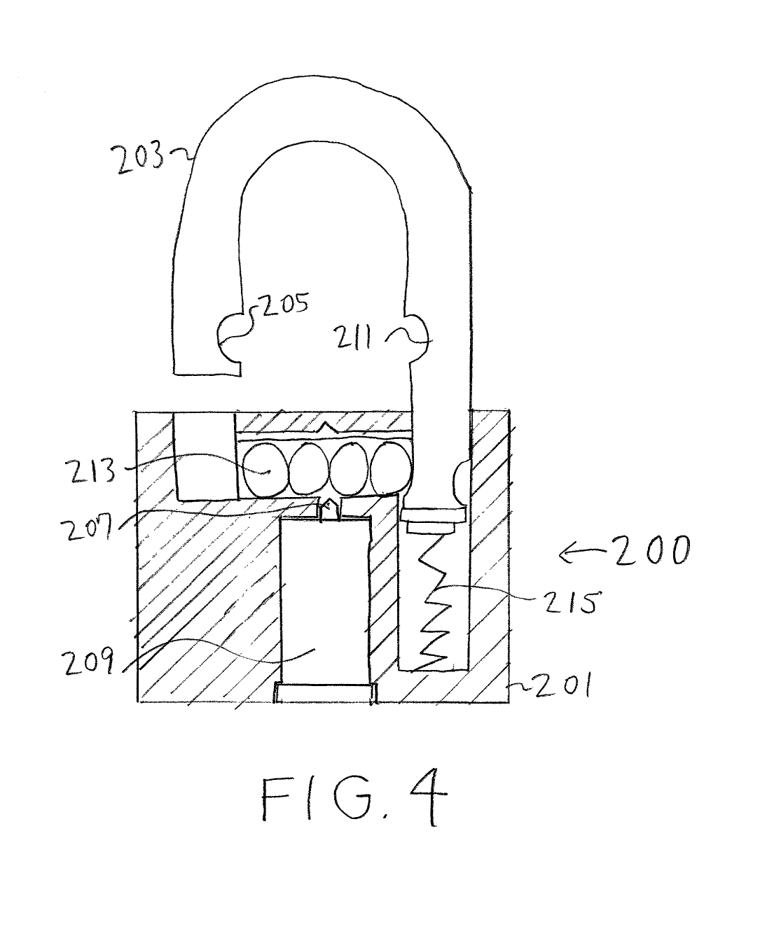

As shown in FIG. 4, upon insertion of a proper key into the lock cylinder 209 and rotation of the key to the open position, the bolt 207 is retracted into the lock cylinder 209. With the bolt 207 retracted, the ball bearings are allowed to cam inward upon pulling up of the shackle 203, thereby releasing the shackle from the housing body 201 with the aid of the spring 215.

The popout cylinder 209 may be a standard popout lock cylinder, not specifically designed for a padlock. Additionally, the popout cylinder 209 may be installed in the padlock housing body 201 in an interchangeable manner, whereby different cylinders may be exchanged for an existing cylinder.

The invention being thus described, it will be apparent to those skilled in the art that the same may be varied in many ways without departing from the spirit and scope of the invention. For example, while the disclosed embodiment uses ball bearings, other movable locking mechanisms could be used, such as dogs, rods or the like. Additionally, while the disclosed embodiment uses a key, it may be possible for the lock cylinder to be actuated using other mechanisms, such as a combination dial or other coded keyless device. These and all other such modifications are intended to be included within the scope of the following claims.

What is claimed is:

1. A padlock, comprising:
a housing body including a movable locking mechanism provided in a channel;
an elongated shackle movably provided in said housing body, said elongated shackle having a notch for receiving said movable locking mechanism therein when said shackle is in a closed position within said housing body;
a popout lock cylinder having a bolt extendable and retractable out of and into said lock cylinder;
said bolt being extendable into said channel containing said locking mechanism to force said locking mechanism against said notch, thereby locking said shackle in said closed position;
said bolt further being retractable into said popout lock cylinder to release said locking mechanism from said notch, thereby allowing said shackle to be raised to an open position out of said housing body.

2. The padlock of claim 1, wherein said movable locking mechanism is a ball bearing.

3. The padlock of claim 2, wherein said notch is a rounded notch that receives said ball bearing.

4. The padlock of claim 2, further comprising a plurality of ball bearings.

5. The padlock of claim 4, wherein said shackle further includes a second rounded notch adapted to receive a second ball bearing at an end of said shackle opposite the first rounded notch.

6. The padlock of claim 1, wherein said lock cylinder is rotatable through rotation of a proper key into a keyway of the lock cylinder, rotation of said lock cylinder causing retraction and extension of said bolt.

7. A padlock, comprising:
a housing body including a movable ball bearing provided in a channel;
an elongated shackle movably provided in said housing body, said elongated shackle having a rounded notch for receiving said movable ball bearing therein when said shackle is in a closed position within said housing body;
a popout lock cylinder having a bolt extendable and retractable out of and into said lock cylinder;
said bolt being extendable into said channel containing said movable ball bearing to force said ball bearing against said rounded notch, thereby locking said shackle in said closed position;
said bolt further being retractable into said popout lock cylinder to release said ball bearing from said rounded notch, thereby allowing said shackle to be raised to an open position out of said housing body.

8. The padlock of claim 7, further comprising a plurality of ball bearings.

9. The padlock of claim 8, wherein said shackle further includes a second rounded notch adapted to receive a second ball bearing at an end of said shackle opposite the first rounded notch.

10. The padlock of claim 7, wherein said lock cylinder is rotatable through rotation of a proper key into a keyway of the lock cylinder, rotation of said lock cylinder causing retraction and extension of said bolt.
